(19) United States
(12) Patent Application Publication
(10) Pub. No.: US 2002/0144906 A1
(43) Pub. Date: Oct. 10, 2002

(54) Auxiliary heater for capillary electrophoresis instruments for enhanced sequencing applications

(76) Inventors: Thomas F. Naughton, Cromwell, CT (US); Michael Nuzzo, Clinton, CT (US); Marie Ruiz-Martinez, Bethany, CT (US); Bruce Robert Seitz, Waterford, CT (US); Bruce E. Tallion, Middletown, CT (US); Daniel Wagner, Hamden, CT (US); J. Christopher Gallo, Meriden, CT (US)

Correspondence Address: MINTZ, LEVIN, COHN, FERRIS,, GLOVSKY and POPEO, P.C., One Financial Center, Boston, MA, 02111, US

(21) Appl. No.: 10/047,201

(22) Filed: Jan. 14, 2002

Related U.S. Application Data
(60) Provisional application No. 60/261,514, filed on Jan. 12, 2001.
(60) Provisional application No. 60/334,678, filed on Nov. 1, 2001.

(51) Int. Cl. G01N 27/26; G01N 27/447

(52) U.S. Cl. 204/451; 204/601

(57) ABSTRACT

The present invention provides an auxiliary heater for use in a capillary electrophoresis device. The auxiliary heater includes a heating element and a thermally non-conductive housing. The auxiliary heater is disposed around the capillary array of the electrophoresis device along a portion of its length. The auxiliary heater is maintained at a temperature above that of the heating chamber of the electrophoresis device. The auxiliary heater allows increased read lengths and shorter run times than existing capillary electrophoresis devices.

### RELATED APPLICATIONS

This application claims priority to U.S. Provisional Applications Ser. No. 60/261,514, filed Jan. 12, 2001, and Ser. No. 60/334,678, filed Nov. 1, 2001, each of which is incorporated herein by reference in its entirety.

### BACKGROUND OF THE INVENTION

1. Field Of The Invention

The present invention relates to a method and apparatus for performing electrophoresis. More particularly, it relates to a method and apparatus for providing increased temperature in capillary electrophoresis.

2. Discussion of Related Art

Electrophoresis is a technique for analyzing components of a mixture, usually by separating the components as they move through a medium comprising a solution-filled matrix that is subjected to an electrical field. Various porous compounds may be used as the matrix, including but not limited to gels made of starch, agar or polyacrylamide. Separation of the mixture is generally based on differences in net electrical charge of the various component molecules, but is also based on size or geometry of a molecule, depending on the matrix and buffer solution being used. Typically, the medium is retained either between parallel plates or in a capillary array. As the electric field is applied, the process generates heat. The electric field and temperature must be accurately controlled to adequately resolve sample components during the electrophoretic operation.

Electrophoresis is used for gene sequencing and genotyping to separate and identify nucleic acid sequences, as well as polypeptide sequences. Successful resolution of the biological molecules is dependent upon the electric field, temperature and time of the electrophoretic run. If the medium is maintained at an optimized higher temperature, a more accurate and more expeditious detection of compounds can be obtained, due in part to better resolution of individual components. For plates, a heat exchanger is thermally attached to at least one of the plates for maintaining the proper temperature of the medium. However, for a capillary array, the entire chamber, including the capillary array and surrounding equipment, is heated. The use of a general heating mechanism in a capillary array electrophoresis machine limits the temperatures at which the medium can be maintained without distorting or damaging other parts of the device.

For example, the MegaBACE instruments (Amersham Pharmacia Biotech) are used as an electrophoresis platform with a capillary array for numerous nucleic acid sequencing and genomics applications. The chamber in this device can be maintained between 27° and 50° C. Within these temperatures, increased read length is possible only with a lower electric field voltage and/or longer runtime, which decreases efficiency in high throughput operations. Another leading device, the Prism DNA Analyzer (Applied Biosystems), has similar limitations. Therefore, a need exists for a capillary array electrophoresis device that can increase the temperature of the medium in the capillaries. A need exists for a capillary array electrophoresis device that allows shorter runtime and increased resolution of bases of longer sequence lengths. Preferably, the needed system can be used in existing capillary array electrophoresis devices.

### SUMMARY OF THE INVENTION

The present invention substantially overcomes the deficiencies of existing capillary array electrophoresis devices by providing an auxiliary heater around at least a portion of the capillary array. The auxiliary heater of the present invention allows the temperature of the medium in the capillaries to be increased without substantially increasing the temperature of the chamber. The auxiliary heater utilizes a non-conductive heating blanket to prevent interference with the electric field. The auxiliary heater will have various shapes and lengths depending upon the chamber and capillary array design. According to one embodiment of the invention, the auxiliary heater operates at approximately 60° C. with an electrical field of approximately 109 V/cm.

Other features and advantages of the invention will be apparent from the following detailed description and claims.

### BRIEF DESCRIPTION OF THE DRAWINGS

FIG. 1 is a perspective view of an auxiliary heater according to a first embodiment of the present invention.

FIG. 2 is a front view of a capillary electrophoresis device including an auxiliary heater according to an embodiment of the present invention.

FIG. 3 is a perspective view of an auxiliary heater according to a second embodiment of the present invention.

FIG. 4 is a perspective view of an auxiliary heater according to a third embodiment of the present invention.

FIGS. 5A and 5B are graphs of Phred scores obtained using an embodiment of the present invention.

FIG. 6 is a graph of read lengths and runtimes obtained using an embodiment of the present invention.

FIG. 7 is a graph of read lengths and runtimes obtained using an embodiment of the present invention.

FIG. 8 is a graph of read length contours obtained using the first embodiment of the present invention.

FIG. 9 is a graph of run time contours obtained using the first embodiment of the present invention.

FIG. 10 is a graph of read length contours obtained using the third embodiment of the present invention.

FIG. 11 is a graph of run time contours obtained using the third embodiment of the present invention.

### DETAILED DESCRIPTION OF PREFERRED EMBODIMENTS

The present invention includes an auxiliary heater which can be utilized in the chamber of a capillary array electrophoresis device, such as a MegaBACE or Prism DNA Analyzer. The auxiliary heater is placed to surround a portion of the capillary array. The temperature of the auxiliary heater is controlled such that the medium in the capillary array is maintained at a higher temperature than the chamber itself.

FIG. 1 illustrates the construction of an auxiliary heater according to a first embodiment of the present invention. The auxiliary heater 10 includes three principal elements: a heating element 12, an epoxy resin base 13, and a heat shroud 11. As illustrated in FIG. 1, the epoxy resin base 13 is a flat rectangular piece approximately 84.8 mm long, 40.0 mm wide, and 16.6 mm thick. One surface of the epoxy resin base 13 is notched to allow the capillaries to rest upon the surface. A thin heating pad 12 is permanently embedded longitudinal to the midsection of the epoxy resin base 13. A thermocouple, not shown, is also permanently embedded in the epoxy resin base 13. Wire leads 14 extend from the thermocouple and the thin heating pad 12 for control of the temperature of the thin heating pad. Preferably the wire leads 14 are insulated. More preferably, the insulation surrounding a wire lead 14 is highly non-conductive. The epoxy resin base 13 may be thermally conductive and electrically isolating. This allows the medium in the capillaries to be heated without interfering with the electric field. A suitable material is available from Epoxies, Etc. of Greenville, R.I. as Part No. 50-3100R Black and Catalyst 190. The internal general purpose heating blanket has wire-wound or flexible foil heating elements, which can be positioned closer to the notched surface than the reverse due to the folded wire connectors. Suitable heating elements are available from McMaster-Carr (Catalog 105). The thermocouple may be a type “T” from various manufactures (e.g., McMaster Carr) and is positioned midway between the heating blanket and the notched surface. The U-shaped heat shroud 11 is placed opposite the notched surface of the epoxy resin base 13 to form a channel for the capillaries. The heat shroud may be of a phenolic material.

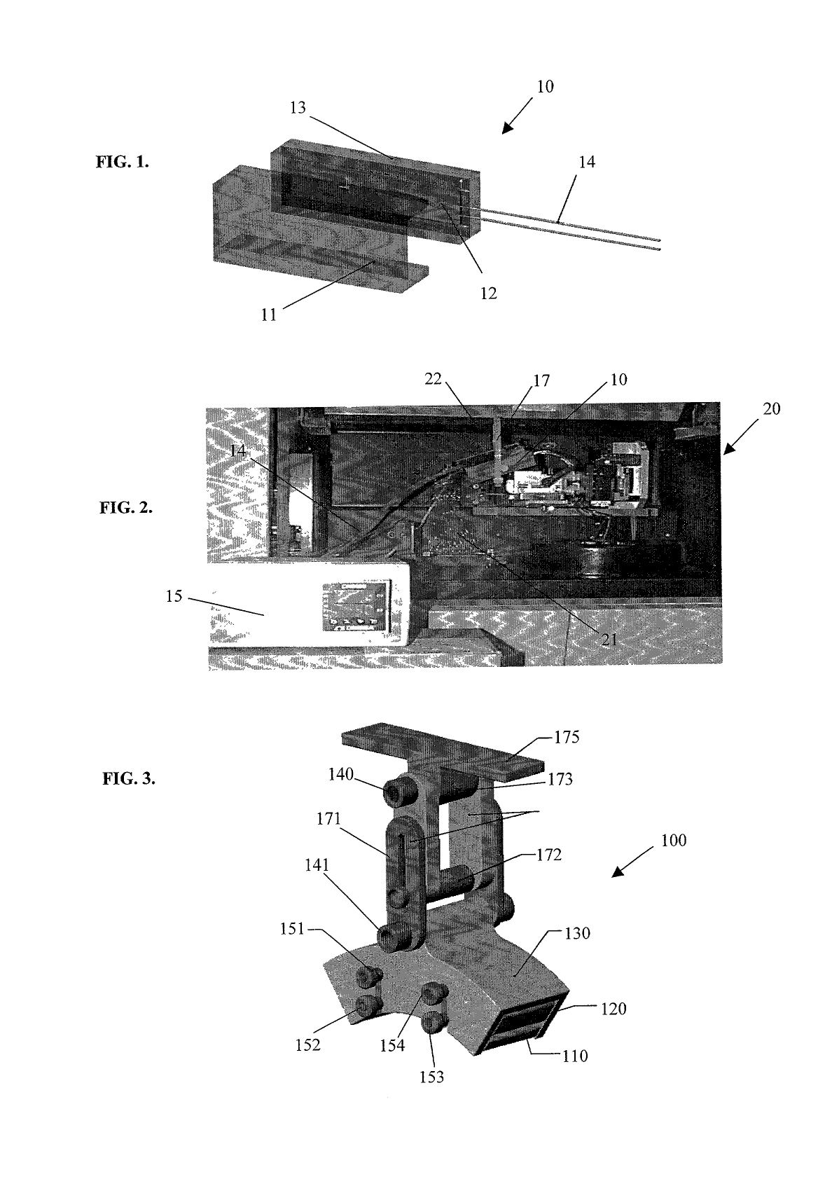

FIG. 2 illustrates an auxiliary heater 10 according to the first embodiment shown in FIG. 1 as placed in a capillary array electrophoresis device 20. The auxiliary heater 10 is suspended from the ceiling 22 of the chamber of the electrophoresis device. A support 17 may be used to suspend the auxiliary heater 10. The auxiliary heater 10 is positioned within the chamber so that a length of the capillaries 21 in the capillary array can be placed within the channel formed by the epoxy resin base 13 and the heat shroud 11. In a specific embodiment utilizing the MegaBACE electrophoresis instrument, the capillaries are 64 cm long. The wire leads 14 from the auxiliary heater 10 are connected to a controller outside the chamber of the electrophoresis device 20. A suitable controller is the Omega CN8500 Series 1/16 DIN Temperature and Process Controller 15. The controller operates to maintain the temperature, as measured by the thermocouple at a desired set point. Alternatively, the auxiliary heater 10 could be controlled by a controller within the electrophoresis device.

With the auxiliary heater, the electrophoresis device is operated in the usual manner. The capillaries are appropriately loaded with the desired medium and genetic material. The temperature and electric field are set according to the usual process for the electrophoresis device. The temperature for the auxiliary heater 10 is set on the controller 14. The electrophoresis process occurs and is assessed in the usual manner for capillary array electrophoresis devices.

FIG. 3 illustrates a second embodiment for an auxiliary heater 100. This embodiment encases the capillaries over an increased length of 12.7 cm compared to the first embodiment of FIG. 1. The second embodiment of the auxiliary heater 100 includes a curved, U-shaped phenolic housing 130 and opposing phenolic bottom 110. The curves of the housing 130 and bottom 110 are such that the capillaries can be placed in the channel formed between them without stress. A heating element 120, which may be embedded in an epoxy resin, is located in the channel of the housing 130. The auxiliary heater 100 of the second embodiment is constructed to allow adjustable positioning within an electrophoresis device. Adjustable brackets 170 connect the housing 130 to a top support 175. The top support can be attached to the ceiling of the chamber of the electrophoresis device. The adjustable brackets 170 allow the position of the auxiliary heater 100 to be changed relative to the chamber. Spacers 172, 173 maintain the positions of the brackets 170. Swivels 140, 141 allow the angles to be adjusted. Thumb screws 151, 152, 153, 154 are used to attach the bottom 110 to the housing 130.

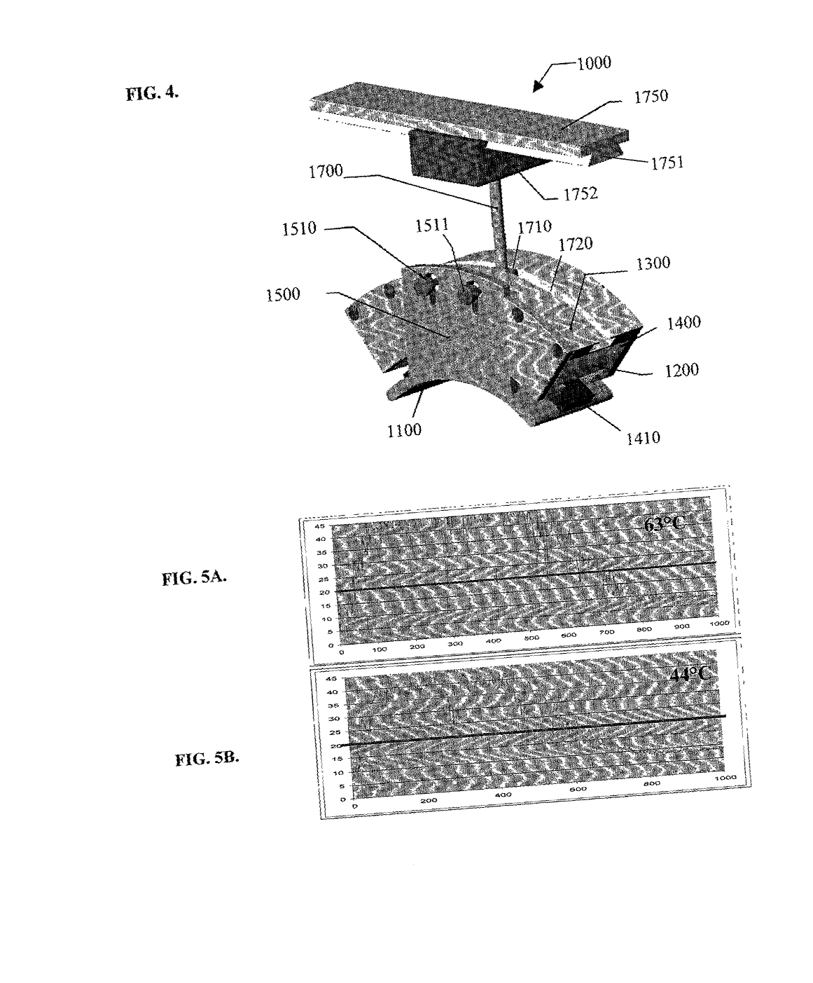

FIG. 4 illustrates a third embodiment of the auxiliary heater 1000 which permits additional adjustments. As with the second embodiment, the auxiliary heater 1000 includes a curved housing 1300 and opposing bottom 1100. A front plate 1500 attached to the bottom 1100 is used to position the housing 1300 and bottom 1100. Thumb screws 1510, 1511 maintain the desired position. The support structure for the auxiliary heater 1000 includes an elongated suspension rail 1750 having a dovetail along one surface. The suspension rail 1750 is attached to the ceiling of the chamber of the electrophoresis device. A slide block 1752 mates with the dovetail 1751 of the suspension rail 1750. An adjustable bolt 1700 extends from the slide block. A slot 1720 along the upper surface of the housing 1300 mates with a head 1710 of the bolt 1700. The position of the auxiliary heater can be adjusted by moving the slide block 1752 relative to the suspension rail 1750, the length of the bolt 1700, and the head 1710 of the bolt 1700 relative to the slot 1720. Since the housing 1300 is curved, movement of the bolt 1700 relative to the slot 1720 also changes the angle of the auxiliary heater. As in the second embodiment, a heating element 1200 extends within the channel formed in the housing 1300. A insulation 1400 may be used between the heating element and the housing. Also, a insulating pad 1410 can be placed along the bottom 1100 within the channel. Various materials can be used for the various elements of the auxiliary heater 1000. However, suitable materials include White Delrin for the housing 1300, bottom 1100 and front plate 1500. Black Delrin can be used for the slide block 1752, and the bolt 1700 can be steel. The suspension rail 1750 may be formed of polypropylene. The insulation 1400 and insulating pad 1410 may be styrofoam or foam neoprene. As discussed above, the heater can be a heat pad embedded in an epoxy resin.

The auxiliary heater of the present invention allows improved performance of sequencing and genomics operations using existing electrophoresis devices. The use of the auxiliary heater unexpectedly achieved an additional 100-150 bases of sequence with suitably high Phred scores in the same run time (90 min.) as using a 44° C. operating temperature. Tests were done using the first embodiment of the auxiliary heater in conjunction with a MegaBACE electrophoresis machine. Sequencing reactions were prepared using DYEnamic ET Dye Terminator Kit (Amhersham, Piscataway, N.J.) following the protocol from the vendor using a ssM13mp18 template (New England Biolab, Beverly, Mass.). The sequencing reactions were then purified using Sephadex (Amhersham) columns in a 96-well plate format. Aliquots of 10 μL of the purified sequencing reaction products were diluted with 10 μL of EDTA (Sigma) to a final concentration of 150 μM EDTA. The samples were then injected into the MegaBACE instruments for 60s at 2 kV and separated at the appropriate electric field. The auxiliary heater was connected to the capillaries inside the MegaBACE and its temperature monitored from an outside controller. The auxiliary heater was powered during the pre-run electrophoresis of the matrix.

The electropherograms were analyzed using a base-caller program of CuraGen called Open Genome Initiative (OGI™). This program can provide Phred scores for all the bases sequenced. The read length for a run was determined using another CuraGen program call RANK. This program compares the obtained sequence to a canonical or control sequence and determines the read-length by comparison. For this program when the base-caller fails to call more than 5 bases in a stretch of 10 bases the read length is terminated; calls with Phred scores below 15 were not taken into consideration.

The use of elevated temperatures provided by the auxiliary heater during the electrophoresis of sequencing fragments aids on the release of any secondary structure of the fragments; thereby improving the linear migration of the fragments and the accuracy of the base call. FIGS. 5A and 5B show the Phred scores as a function of fragment length for the sequencing of a control sample. FIG. 5A represents the Phred scores obtained using an operating temperature of the auxiliary heater of 63° C. FIG. 5B represents the Phred scores obtained using an operating temperature of the auxiliary heater of 44° C., approximately the temperature of the chamber. As seen in FIGS. 5A and 5B, the use of a higher operating temperature resoundingly increases the overall Phred scores for the base calls. Impressively, the efficiency of resolving severe compressions (e.g., at approximately 284 bases in FIG. 5A an FIG. 5B) is greatly increased, as demonstrated by a Phred score over 20, when using the higher operating temperature (i.e., 63°) generate with the device.

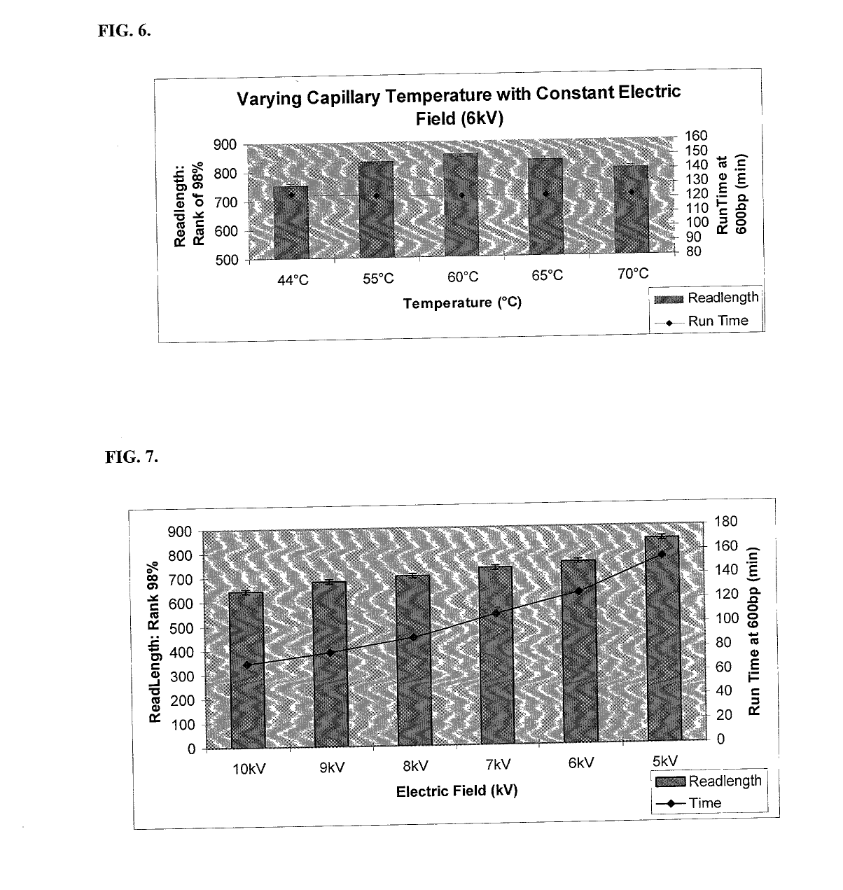

Additional experiments were performed to determine the effects of various temperatures and electric fields when using an auxiliary heater according to the present invention. FIG. 6 shows the effect on the separation, as measured by the read length, of the auxiliary heater operating temperature. FIG. 6 also shows the effect of the temperature on the run time for the analysis. The run time was measured as the time needed to separate fragments 600 bases in length.

An optimum read length can be observed by performing the separation with the auxiliary heater set at 60° C. From this figure it can also be observed that the run time did not vary significant across different temperatures. An additional 100 bases of read length was obtained by increasing the temperature from 44° C. to 60° C. without any significant change on the instrument operation time.

Similarly, FIG. 7 shows the effect of running voltage on the separation of sequencing fragments. The runs were performed using a constant auxiliary heater temperature of 60° C. FIG. 7 shows that the read length is increased with decreasing electric field but at the expense of analysis time. About 200 additional base calls can be obtained by dropping the voltage from 10 kV to 5 kV, but the analysis time is increased 70 to 160 minutes for the separation of fragments 600 bases in length.

The use of the auxiliary heater of the present invention clearly produces improvements in the number of bases read and the runtime. A set of experiments were performed to optimize the performance for both temperature and electric field. Table A lists the conditions for each of 22 trials. The conditions were performed on a MegaBACE device with capillary length of 64 cm. Voltage ranged from 5 kV to 10 kV. Given these parameters, the electrical fields tested were calculated to be between 78 V/cm and 156 V/cm. The separation matrix used was linear polyacrylamide (Amersham), the injection time was 60s at 2kV and 10 minutes pre-run were used at 8 kV. The data was analyzed using OGI base caller and RANK programs, as discussed above. The data from all of the trials was then further analyzed using experimental Echip design software, from Echip, Inc., to optimize the temperature and electric field to obtain a maximum read length in minimum time.

TABLE A

| | Temperature of the | Voltage for the |
|---|---|---|
| Trial Number | auxiliary heater (° C.) | electrophoresis (kV) |
| 1 | 44 | 10 |
| 2 | 44 | 10 |
| 3 | 44 | 9 |
| 4 | 44 | 8 |
| 5 | 44 | 7 |
| 6 | 44 | 6 |
| 7 | 44 | 5 |
| 8 | 55 | 6 |
| 9 | 60 | 5 |
| 10 | 60 | 6 |
| 11 | 60 | 7 |
| 12 | 60 | 8 |
| 13 | 65 | 6 |
| 14 | 70 | 6 |
| 15 | 70 | 6 |
| 16 | 70 | 7 |
| 17 | 70 | 8 |
| 18 | 90 | 8 |
| 19 | 85 | 8 |
| 20 | 85 | 8 |
| 21 | 80 | 8 |
| 22 | 50 | 8 |

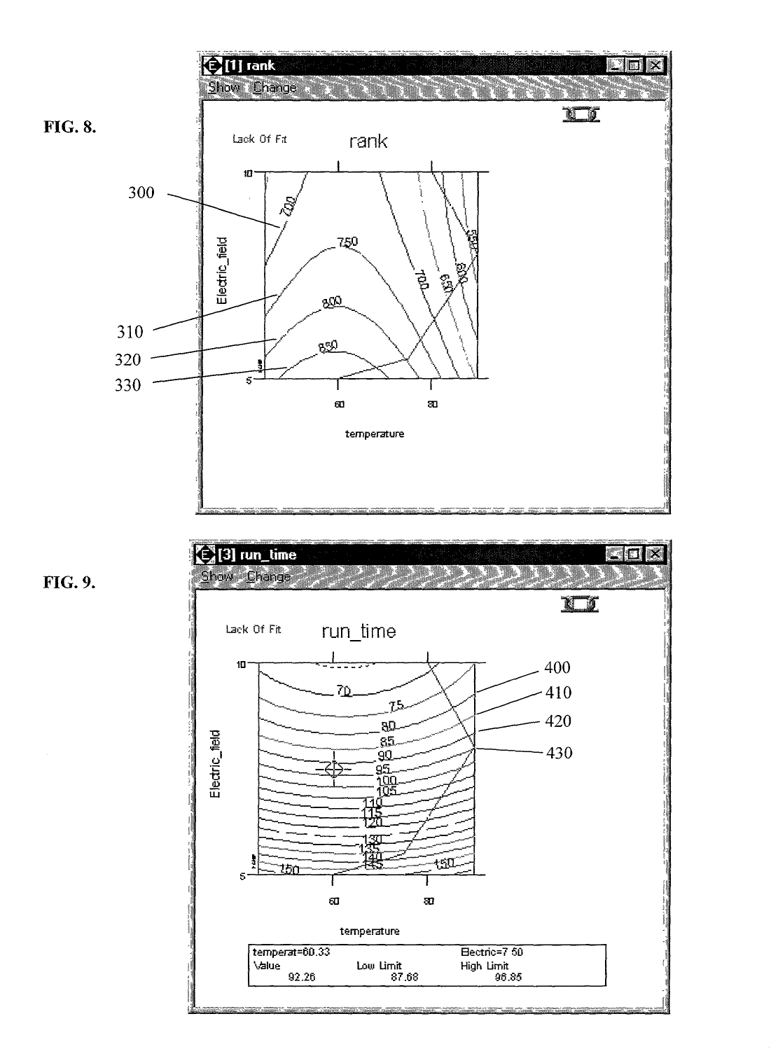

FIGS. 8 and 9 illustrate contour plot outputs of the Echip program analyzing the read length and runtimes as functions of electric field and temperature. In FIG. 8, each of the contours 300, 310, 320, 330 represent maximum read lengths. Similarly, in FIG. 9, each of the contours 400, 410, 420, 430 represent run times to obtain 600 bases.

From this experiment it can be observe in FIG. 8 that a maximum read length can be obtained around 5.5 kV and using an operating temperature of 60° C. The electrical field under these parameters is calculated to be 86 V/cm. However, from FIG. 9, it can be observed that the run time decreases with increasing electric field used. Both of these variables were then optimized at the same time. The Echip software allows for the variables to be weighted before the optimization. An equivalent weight was given to both read length and run time. The optimized values obtained were at a voltage of 7.5 kV, an electric field of 117 V/cm, and an operating temperature of 60° C. Using these values an average read length of 800 bases can been achieved in a run time of 90 minutes. The use of elevated temperatures for sequencing provides two important benefits: improved accuracy and increase read lengths.

Similar experiments were performed using the longer auxiliary heater of the third embodiment shown in FIG. 4. Twenty-six trials were performed. The conditions for the trials are set forth in Table B. Again, the capillaries were 64 cm in length, the separation matrix used was linear polyacrylamide (Amersham), the injection time was 60s at 2 kV and 10 minutes pre-run were used at 8 kV. The data was analyzed using OGI base caller and RANK programs.

TABLE B

| | Temperature of the | Voltage for the |
|---|---|---|
| Trial Number | auxiliary heater (° C.) | electrophoresis (kV) |
| 1 | 44 | 10 |
| 2 | 44 | 10 |
| 3 | 44 | 9 |
| 4 | 44 | 8 |
| 5 | 44 | 7 |
| 6 | 44 | 6 |
| 7 | 44 | 5 |
| 8 | 55 | 6 |
| 9 | 60 | 5 |
| 10 | 60 | 6 |
| 11 | 60 | 7 |
| 12 | 60 | 8 |
| 13 | 65 | 6 |
| 14 | 70 | 6 |
| 15 | 44 | 6 |
| 16 | 70 | 7 |
| 17 | 70 | 8 |
| 18 | 90 | 8 |
| 19 | 85 | 8 |
| 20 | 85 | 8 |
| 21 | 80 | 8 |
| 22 | 50 | 8 |
| 23 | 75 | 9.5 |
| 24 | 60 | 10 |
| 25 | 80 | 10 |
| 26 | 75 | 5.5 |

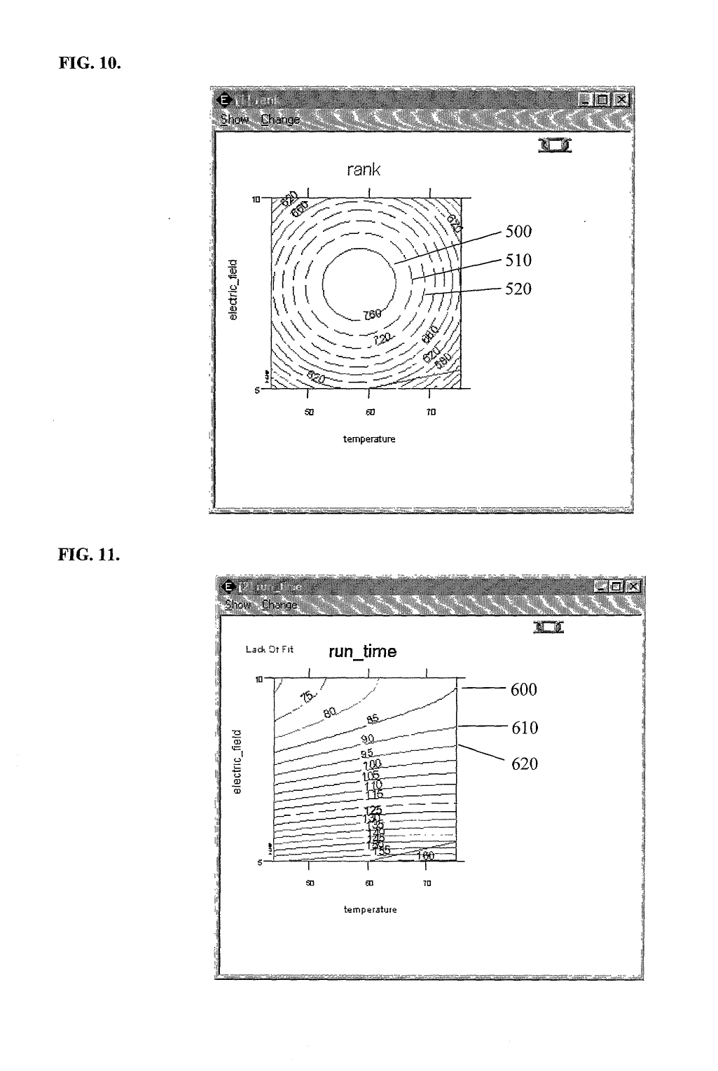

FIGS. 10 and 11 illustrate the read length and runtime contour plots from the Echip software from the twenty-six trials with the third embodiment of the auxiliary heater. A maximum read length can be found from FIG. 10 at approximately 7.5 kV and using an operating temperature of 60° C. The optimized values obtained, considering both read length and run time, were a voltage of 8.5 kV, an electric field of 133 V/cm, and an operating temperature of 60° C. Using these values an average read length of 780 bases can been achieved in a run time of 90 minutes.

Electrophoretic analysis of nucleic acids are routinely run at a voltage of 7 kV, an electric field of 109 V/cm, and an operating temperature of 60° C.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described above. All publications, patent applications, patents, and other references mentioned herein are incorporated by reference in their entirety. In the case of conflict, the present specification, including definitions, will control. In addition, the materials, methods, and examples are illustrative only and not intended to be limiting.

Of course, those of ordinary skill in the art will recognize that adaptations and modifications can be made to the design and operation of the auxiliary heater of the present invention. The auxiliary heater may also be incorporated with an electrophoresis device. The dimensions, shape and materials of the auxiliary heater may also be changed. Accordingly, the scope of the invention is not limited to the embodiments disclosed and is only limited by the claims hereto. Modifications and adaptations to the invention are incorporated within the scope of the claims.

We claim:

1. A capillary electrophoresis apparatus comprising:
a heating chamber maintained at a first temperature;
at least one capillary arrayed within said heating chamber, said capillary having a length;
a heater disposed within said heating chamber and surrounding the capillary along a portion of the length of the capillary, the heater being maintained at a second temperature higher than said first temperature; and
an electric field across the capillary.

2. The capillary electrophoresis apparatus according to claim 1, wherein the second temperature is in the range of 50° C. to 90° C.

3. The capillary electrophoresis apparatus according to claim 1, wherein the second temperature is in the range of 55° C. to 65° C.

4. The capillary electrophoresis apparatus according to claim 1, wherein the second temperature is approximately 60° C.

5. The capillary electrophoresis apparatus according to claim 1, wherein the electric field is in the range of 78 V/cm to 156 V/cm.

6. The capillary electrophoresis apparatus according to claim 1, wherein the electric field is in the range of 94 V/cm to 125 V/cm.

7. The capillary electrophoresis apparatus according to claim 1, wherein the electric field is approximately 109 kV/cm.

8. The capillary electrophoresis apparatus according to claim 1, wherein the heater includes:
a heating element contacting at least one capillary of the capillary array; and
a thermally non-conductive housing associated with the heating element to maintain the capillary in contact with the heating element.

9. The capillary electrophoresis apparatus according to claim 8, wherein the heating element includes an thermally conductive epoxy resin.

10. The capillary electrophoresis apparatus according to claim 8, wherein the heating element includes a support attaching the heating element to a surface of the heating chamber.

11. The capillary electrophoresis apparatus according to claim 10, wherein the support is adjustable to position the heating element relative to the capillary.

12. A method of performing electrophoresis comprising the steps of:
disposing one or more electrophoresis capillaries within a chamber, said capillary having a length, and the chamber being maintained at a first temperature;
heating at least a portion of the length of the capillary to a second temperature higher than the first temperature; and
establishing an electric field across the length of the capillary.

13. The method of performing electrophoresis according to claim 12, wherein the second temperature is in the range of 50° C. to 90° C.

14. The method of performing electrophoresis according to claim 12, wherein the second temperature is approximately 60° C.

15. An auxiliary heater for use in a capillary electrophoresis device comprising:
a heating element having a length less than the length of a capillary of the capillary electrophoresis device; and
a thermally non-conductive housing associated with the heating element to form a channel between at least a portion of the housing and the heating element, the channel being sized to encompass one or more capillaries.

16. The auxiliary heater according to claim 15, wherein the heating element includes an thermally conductive epoxy resin.

17. The auxiliary heater according to claim 15, wherein the heating element includes a support attaching the heating element to a surface of a chamber of the capillary electrophoresis device.

18. The auxiliary heater according to claim 17, wherein the support is adjustable to position the heating element relative to the capillary array.

19. The auxiliary heater according to claim 18, wherein the support includes:
a first element allowing movement of position of the heating element within the chamber; and
a second element allowing movement of the angle of the heating element relative to the surface of the chamber.

20. The auxiliary heater according to claim 15, further comprising at least one insulating member disposed within the channel.

21. The auxiliary heater according to claim 15, wherein the heating element is substantially planar.

22. The auxiliary heater according to claim 15, wherein the heating element is curved along a length of the channel.

23. A method of resolving nucleic acids in a population of nucleic acids, wherein a first nucleic acid of the population differs in length from a second nucleic acid of the population by one or more nucleotides, comprising the steps of:
disposing one or more electrophoresis capillaries within a chamber, said capillary having a length, and the chamber being maintained at a first temperature;
heating at least a portion of the length of the capillary to a second temperature higher than the first temperature; and
establishing an electric field across the length of the capillary.

24. The method of performing electrophoresis according to claim 23, wherein the second temperature is in the range of 50° C. to 90° C.

25. The method of performing electrophoresis according to claim 23, wherein the second temperature is approximately 60° C.
